(19) United States
(12) Patent Application Publication
(10) Pub. No.: US 2003/0225609 A1
(43) Pub. Date: Dec. 4, 2003

(54) System for marketing and distributing media or product via electronic networking and publishing

(76) Inventor: John Martin Klipfell III, Strongsville, OH (US)

Correspondence Address: John M. Klipfell III, 17573 Pioneers Creek Circle, Strongsville, OH, 44136, US

(21) Appl. No.: 10/156,522

(22) Filed: May 28, 2002

(51) Int. Cl. G06F 17/60

(52) U.S. Cl. 705/10

(57) ABSTRACT

A method and process for informing end-consumers with Internet access of the existence of a work of intellectual property with potential end-consumer appeal, and encouraging said end-users to acquire the work for their use. The method and process comprises the steps of (1) providing an initial end-consumer with a free sample portion of the work, (2) providing said initial end-consumer with a choice of either acquiring the balance of the work at a stated price, or alternatively for free or for a reduced price, on the condition of (3) that the initial end-consumer agrees to send one or more personal endorsement e-mails or electronic communications to one or more other end-consumers to recommend that they in turn consider acquisition of the work of intellectual property through the same aforementioned method and process and steps.

### FEDERALLY SPONSORED RESEARCH

Not Applicable.

### SEQUENCE LISTING OR PROGRAM

Not Applicable.

### BACKGROUND—FIELD OF INVENTION

This invention relates to a system for marketing and distributing product via the Internet. The product is marketed to the end-consumer through the use of compensated, personal endorsement e-mail from one end-consumer to another.

### BACKGROUND OF THE INVENTION

The Applicant desires to maximize distribution of a product comprising primarily of intellectual property, which is in this case is a work of literary composition. The Applicant was aware of the challenges and obstacles he would face, as an unknown and previously unpublished author, in realizing his goal of successfully and profitably getting a large number of people to read his work of literary composition. Accordingly, the Applicant developed a process that he believed would overcome many of those challenges and obstacles. That process is the subject of this patent application. The public launch of the Applicant's website, HubrisBooks.com, subsequent to the filing date of this patent application, represents the reduction to practice of a preferred embodiment of this process.

The current process of writing, publishing, marketing, and distributing a book or other form of literary composition involves many steps. If an author's objective is to have a large number of end-consumers actually read his work of literary composition, he faces many obstacles in the current marketplace, and will likely be unsuccessful. This is particularly true if the author is relatively unknown or previously unpublished.

Writing a work of literary composition. Innumerable people aspire to write a book or other form of literary composition. In practice however, few people successfully create a work of literary composition that the end-consumer public will find of sufficient interest to acquire, read, and enjoy. For those who do succeed in creating a work of literary composition with potential end-consumer appeal, the process of getting a large number of end-consumers to actually read it is a daunting task. That task can include the pursuit of several different approaches and alternatives for getting the work of literary composition published, marketed, and distributed.

Publication of a work of literary composition as a physical hard copy book by an established publisher. The first obstacle that an aspiring author typically faces is to convince various literary agents, editors, publishers, and others that his or her work of literary composition has potential end-consumer appeal. Frequently, an author presents his or her literary composition to a literary agent. If the literary agent believes that the literary composition has potential end-consumer appeal, the literary agent may present the literary composition, on the author's behalf, to editors, publishers, or others in an effort to convince them that the work of literary composition has potential end-consumer appeal. If one of these parties in turn agrees that the work of literary composition has sufficient end-consumer appeal to justify publication, marketing, and distribution of the work, the work of literary composition might be published in physical book form.

A second obstacle is the cost and economics of actually publishing, marketing, and distributing a work of literary composition as a physical book in sufficient quantities to make possible the objective of having a large number of end-consumers acquire, read, and enjoy the work. While tens of thousands of physical books are published annually, because of the high cost of sourcing the literary composition, physically publishing the book, warehousing and distributing the inventory, and marketing the book to a fickle and unpredictable end-consumer reading public, proportionately few works of literary composition that are published as physical books are actually acquired, read, and enjoyed by a large number of end-consumers. This is particularly true for works of literary composition from relatively unknown or previously unpublished authors. Large-scale readership and commercial success of a physical book of literary composition is most likely to occur with respect to well-known and previously published authors.

Self-publication of a work of literary composition as a physical book by an author. Self publication by an author essentially eliminates the first obstacle in respect to publication of a work or literary composition as a physical book by an established publisher in that the author does not have to convince a progression of literary agents, editors, and publishers that his or her literary composition has end-consumer appeal. Instead, in this situation, the author takes responsibility for some or all of the costs of self-publication, manufacturing, warehousing, distribution, and marketing. Although innumerable books and articles have been written over the years about the topic, when they self-publish a physical book themselves, few authors actually succeed in successfully and profitably having their work of literary composition read by a large number of end-consumers. Where self-publishing success is periodically realized occurs when an author's self-publishing activities come to the attention of an established commercial publisher, which then agrees to publish, market, promote, and distribute the initially self-published work of literary composition.

E-book publishing. The advent of the Internet introduced the opportunity to distribute a work of literary composition as an e-book to an end-consumer as an electronic file that may be printed, or simply viewed. In recent years, literally tens of thousands of works of literary composition have been electronically published on the Internet in some form of an e-book, both by established publishers, and by authors and other individuals.

For several years, the whole topic of e-books and electronic publishing in general have been the subject of hype, serious discussion, articles and books. For example, in September 1999, the software publisher Abode published a brief titled, “Adobe and eBooks . . . Turning a new page in publishing” that outlined their vision of the future of the coming revolution in book publishing when the end-consumer would read electronically downloaded e-books on e-book readers, personal digital assistants, and other forms of hand held devices. Noted author, Steven King, made history when he sold 400,000 copies of his sixty-six page novella titled, Riding the Bullet, for $2.50 each during the first twenty-four hours after its online publication on Mar. 14, 2000. Later King made history again, in mid-July 2000, when he sold 152,000 copies of chapter one of his serialized book, The Plant, with 76% of end-users who downloaded the installment voluntarily paying $1.00 to receive it. However, by the time the fifth installment of The Plant was delivered, less than half of its readers voluntarily paid the $1.00 fee and that experiment in e-publishing was discontinued.

With all these early developments, one would think that the electronic publishing of e-books would be flourishing and profitable today. Yet, so far, electronic publishing has failed to live-up to its hype and promise. While there are surely many reasons for this failure to date, a few reasons appear obvious at this time.

E-books publishing seems to be focused on the use of e-book readers and personal digital assistants, which are proving to represent an impediment to mass market distribution of works of literary composition. Reasons for this include: a) the high cost and cumbersome nature of acquiring and using these devices; b) the lengthy, prohibitive download time required to download the free software plug-in applications that are necessary to view certain e-book formats and files on stand alone computers; and, c) the e-publishing industry's efforts to protect e-book intellectual property from piracy which puts barriers in the path of end-consumer trial. Altogether, these factors restrict the size of the market for e-books that can be read on e-book readers to substantially less than one million end-users, which is only about 0.3% of the American population.

Despite all the e-book content that is available on the Internet waiting to be found, it is generally not being discovered by end-consumers in any large-scale manner. Despite hundreds of websites and other sources dedicated to promoting the discovery and end-consumer use of electronically published works of literary composition, there is currently no successful method or process for getting the word out, about the existence of any given work of literary composition with consumer appeal to the hundreds of millions of potential end-consumers who could access, acquire, download, print and/or view and read such work if they were informed that it existed.

Unsolicited e-mail marketing. It has become commonplace for e-mail users to receive numerous unsolicited e-mails from entities which are promoting all manner of product and service. While e-mail users may in some cases give permission to on-line marketers to send these types of promotional e-mails, most e-mail users disdain the clutter and intrusion of these unsolicited and unwanted e-mails. In fact, innumerable articles and computer software programs are continually being written and disseminated among e-mail users dealing with this matter, which is popularly called spamming. These articles and programs offer advice, counsel, software filters and other means for screening out and preventing certain types of unsolicited e-mails from reaching e-mail users' in-boxes. Additionally, it should be noted that, when one of these unsolicited e-mails does in fact make it into an e-mail user's in-box, it is frequently deleted without opening by the end-user if it came from a party that he or she is not familiar with. For the entity that is sending the unsolicited e-mail in an attempt to promote a product or service, the above end-consumer deletion activity has the effect of decreasing the commercial effectiveness of their unsolicited e-mail marketing campaign.

Compensated referrals. It is commonplace in America today for one end-consumer to receive some form of compensation in exchange for recommending a product or service to another end-consumer, or for recommending to an entity that is marketing a product or service that they contact another end-consumer who might be interested in the product or service. Examples include: America Online pays a “bounty” to one subscriber who recommends another end-consumer to be a subscriber; and, a magazine gives a special discount to a subscriber who buys a gift subscription for another end-consumer. While a list of examples would be endless, the common denominator to virtually all of these programs is that the compensation is only paid when a successful referral pays off in the form of new business for the entity that is marketing the product or service.

Other forms of intellectual property. While the above paragraphs outline the process and prior art with respect to the creation, publication, marketing and distribution of works of literary composition in their physical and electronic forms, great similarities exist with respect to other forms and works of musical, audio, video, graphical and audio/visual composition that have potential end-consumer appeal. With respect to these other forms of intellectual property, the same or similar obstacles exist with respect to their distribution and enjoyment by a large number of potential end-consumers, as has been outlined above with respect to works of literary composition, and to which the present invention is applicable.

### OBJECTS, ADVANTAGES AND SUMMARY OF THE INVENTION

A principal object of the invention is to provide a means by which an author or publisher of a work of literary composition or other similar form of intellectual property, including relatively unknown or unpublished persons, can successfully publish, market, and distribute their work electronically, utilizing compensated e-mail marketing to reach a large number of end-consumers.

The various objects and advantages of this invention with respect to each step in the typical process of publishing, marketing, and distributing works of literary composition or other similar forms of intellectual property are as follows:

Writing a work of literary composition. The invention pre-supposes that an author has already developed a work of literary composition that has end-consumer appeal.

Publication of work of literary composition as a Physical book by an established publisher. The object and advantage of this invention is to make this step in the customary process unnecessary, or optional.

Self publication of a work of literary composition as a physical book by an author: A principal object and advantage of this invention is to make this step in the process unnecessary, or optional.

E-book publishing. While this invention anticipates that the work of literary composition will be offered to the end-consumer public through the vehicle of a printable and/or viewable electronic file electronically accessible from the Internet, it eschews the view that the best means for the end-consumer to actually acquire and read the work of literary composition will necessarily require use of an e-book reader, personal digital assistant, or similar hand-held device. Instead, the invention permits the end-consumer to simply, easily, and quickly download and either print the electronic file on a home or other printer, and/or view the file on a standard computer monitor, or on any other electronic device.

Although the electronic file to be downloaded could be in any file format, use of a widely used, industry standard file format such as the Abode Acrobat PDF file format is envisioned. Use of the PDF file format is currently envisioned because it is already available to more than 95% of all United States personal computer users and doesn't require use of any unusual software, or software plug-in, because most personal computers already have the PDF file format on file. Accordingly, the end-consumer would experience few, if any, impediments to the process of acquiring and reading a work of literary composition in this manner.

The invention envisions that an electronic publisher of a work of literary composition would divide a work into one or more portions that would be available for free, and one or more portions that would be available for a fee. The free portion would be made freely available to end-consumers for them to download, print and/or view, and read to determine if the work of literary composition is appealing to them, and to determine if they also wished to receive the balance of the work of literary composition that is available to them for a fee. If an end-consumer should find that the free portion of a work is appealing enough for them to decide to read the balance of the work, the end-consumer would be directed to return to the publisher's website where the end-consumer can acquire, download and print and/or view the balance of the work of literary composition that is available for a fee. At that point in the process, the end-consumer would be offered a choice either to outright pay for the balance of the work for a fee by offering his or her credit card or other form of payment, or to receive the work for free, or for a reduced price, is he or she agrees to send a personal endorsement e-mail to one or more of his or her friends or associates.

To the extent that some portion of end-consumers agree to pay for the portion of the work of literary composition that is available for fee at either a full or discounted selling price, the publisher of the work realizes a revenue stream. However, to the extent that some portion of end-consumers choose to send one or more personal endorsement e-mails in consideration for receiving the portion of the work of literary composition that is available for fee, those end-consumers are essentially being compensated for their marketing efforts in spreading the work about the appeal of the work to other end-consumers. Thus the object and advantage of this invention is that it provides a method and process for getting the word out about the existence and consumer appeal of a work of literary composition to the universe composed of the hundreds of millions of potential end-consumers who could electronically access and acquire it over the Internet for their use.

There are many potential variations about how the above process could work. For example, the publisher could simply offer the fee portion of the work of literary composition for free if one or more personal endorsement e-mails are sent. Alternatively, the publisher could offer some percentage or fixed monetary discount if a certain number of personal endorsement e-mails are sent, and another, greater percentage or fixed monetary discount if a larger number of personal endorsement e-mails are sent, and so on. For example, if one personal endorsement e-mail is sent, the sender might receive a $1.00 discount off the stated price of the fee portion of the work of literary composition, if two personal endorsement e-mails are sent, the sender might receive a $2.00 discount, if three personal endorsement e-mails are sent, the sender might receive a $3.00 discount, and so on.

There are also many potential variations about how and what form the personal endorsement e-mails might take. For example, the personal endorsement e-mail might take the form of a pre-formatted, pre-written message that the publisher had previously written where the sender only provides the e-mail addresses of the intended recipients. Alternatively, the sender of the personal endorsement e-mail might be allowed some or complete latitude to compose some or all of the personal endorsement e-mail that is to be sent.

Unsolicited e-mail marketing Because this invention provides that the personal endorsement e-mail to be sent by one end-consumer to another bears at least the personal e-mail address of the referring end-consumer, the personal endorsement e-mail is unlikely to be viewed as spam and will more likely be opened and favorably acted upon by the end-consumer recipient. Thus, an object and advantage of this invention is to facilitate the spreading of the word about the consumer appeal of a work of literary composition by circumventing to some degree the software filters and other restrictions that end-consumers use to screen incoming e-mails.

Compensated referrals. The object of this invention is to provide compensation, in the form of a reduced purchase price for the portion of a work of literary composition that is available for a fee, in return for the act of sending one or more personal endorsement e-mails to others, regardless of whether or not the parties receiving the personal endorsement e-mails decide to act on the endorsements in any manner. Accordingly, an object and advantage of this invention is to encourage trial or inspection among a hopefully growing number of end-consumers with respect to a work of literary composition, hence continually spreading the word about the existence and appeal of the work of literary composition.

Other forms of intellectual Property. While the above paragraphs outline objects and advantages of the invention with respect to the creation, publication, marketing and distribution of works of literary composition in their physical and electronic forms, great similarities exist with respect to other forms and works of musical, audio, video and audio/visual compositions that have potential end-consumer appeal. With respect to these other forms of intellectual property, the same or similar objects and advantages would exist with respect to their distribution and enjoyment by a potentially large number of end-consumers, as has been outlined above with respect to works of literary composition.

This invention provides a method and process for getting the word out about the existence and consumer appeal of a work of literary composition, or other form of digitized intellectual property, to the universe composed of the hundreds of millions of potential end-consumers who can electronically access and acquire it over the Internet through the use of compensated, personal endorsement e-mail marketing.

### BRIEF DESCRIPTION OF THE FIGURES

In the accompanying Figures:

FIG. 1 is a textual and graphical layout of an introductory display screen of the electronic publishing system of the invention;

FIG. 2 is a textual and graphical layout of a sequential display screen of the electronic publishing system of the invention, setting forth a description of parts and procedures for acquiring one or more parts of a distributable work;

FIG. 3 is a textual and graphical layout of a sequential display screen of the electronic publishing system of the invention, setting forth a print option for acquiring a portion of a published work;

FIGS. 4A and 4B are textual and graphical layouts of a sequential screen displays of the electronic publishing system of the invention, setting forth data transfer options for a portion of a published work;

FIG. 5 is textual and graphical layouts of a sequential screen display of the electronic publishing system of the invention, setting forth instructions for data transfer of a part of a published work;

FIG. 6 is a textual and graphical layout of a sequential screen display of the electronic publishing system of the invention, setting forth data transfer options for a portion or portions of a published work;

FIG. 7 is a textual and graphical layout of a sequential screen display of the electronic publishing system of the invention, setting forth an acquisition option for a portion of a published work, and providing for recipient data input;

FIG. 8 is a textual and graphical layout of a sequential screen display of the electronic publishing system of the invention, setting forth an acquisition option for a portion of a published work, and providing for subsequent recipient data input;

FIG. 9 is a textual and graphical layout of a sequential screen display of the electronic publishing system of the invention, setting forth acquisition options for a portion of portions of a published work;

FIGS. 10 and 11 are textual and graphical layouts of sequential screen displays of the electronic publishing system of the invention, setting forth information on data transfer of a published work, and

FIG. 12 is a block diagram representing functions and data transfers performed by the electronic publishing system of the invention.

### DETAILED DESCRIPTION OF THE INVENTION

There may be alternative preferred embodiments of this invention based on the nature, type, length, price, anticipated end-consumer appeal, and other characteristics of the work of literary composition, or other form of intellectual property, intended to be marketed to some or all of the universe composed of the hundreds of millions of potential end-consumers who may electronically access and acquire the work or property.

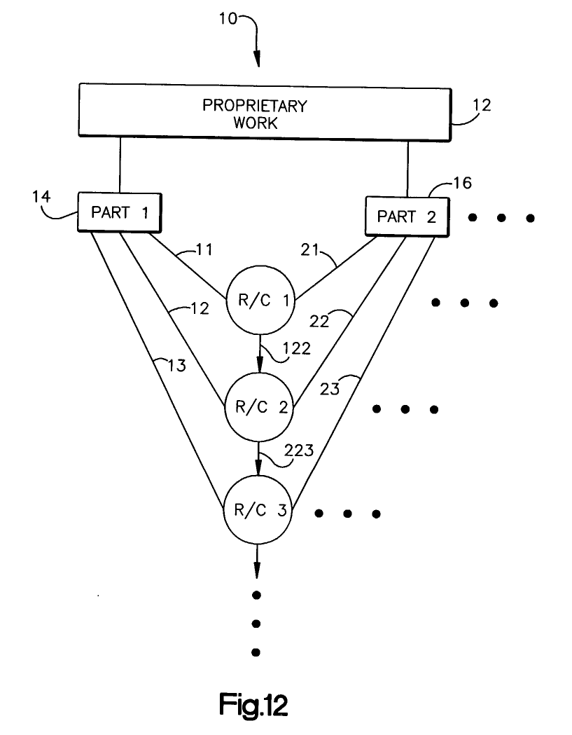

FIG. 12 schematically represents a conceptual framework of the invention, wherein a proprietary work 12, such as a literary work or text or compilation of any information or data, is divided into two or more parts, such as for example PART 1 (14), PART 2 (16), etc. The division of the work 12 may be in as few as two parts, or into as may as desired. With the work 12 in a computer file format, the divided parts 14, 16, etc. are defined as separate computer files which are transferable as further described.

R/C 1 represents a first receiver/consumer who, through an electronic/computer connection with a server on which the proprietary work 12 resides, receives by data transfer via connection path 11 PART 1 of the work 12. The commercial terms of the transfer of PART 1 to R/C 1 are addressed in connection with the electronic transfer, as further described. A networked connection 122 between R/C 1 and R/C 2 serves the dual function of a referral or notice of availability of the work 12 to R/C 2, and as a pre-condition to the transfer of PART 2 of the work to R/C 1, represented by line 21. In other words, the notification to R/C 2 (and others) of the on-line availability of PART 1 of the work 12 is a condition precedent to R/C 1 receiving PART 2 from the proprietor of the work 12 on certain commercial terms (for example, free, if the referral is made to at least one other receiver/consumer. Importantly, the referral message as represented by line 122 does not have to be to a single receiver/consumer, but is preferably broadcast to multiple receivers/consumers, as represented by the dots to the right of R/C 2.

R/C 2 may similarly receive PART 2 by data transfer represented by line 22 (after receipt of PART 1 by acting on the referral from R/C 1) by then referring at least to R/C 3, by connection 223, and others (represented by the dots to the right of R/C 3). This repeated broadcast of referrals of the work 12 to others as a pre-condition to receipt of subsequent parts of the work on certain commercial terms is a principal and object of the invention. However, as further explained, the electronic publishing and distribution system of the invention does not have to be hard-wired to require a referral prior to transfer of subsequent parts of the work, but may alternatively provide a user the option of acquiring subsequent parts on different commercial terms (e.g. payment) in lieu of providing network-distributed referrals.

These principals, concepts and objects of the invention are now further described in connection with a particular Internet-based execution of the invention for a particular type of work, it being understood that the invention is executable in other types of networked computer environments, and in connection with any type of information or data which is transferable as an electronic or digital file.

The following describes a preferred embodiment of the invention with respect to Applicant's work of literary composition titled Hubris, which the Applicant believes to have end-consumer appeal. The description that follows is based on the related reduction to practice of the invention as evidenced by the public launch of the Applicant's website, HubrisBook.com, subsequent to the filing date of this patent application. As noted, the system of the invention is applicable to any type of work which is transferable over a computer network.

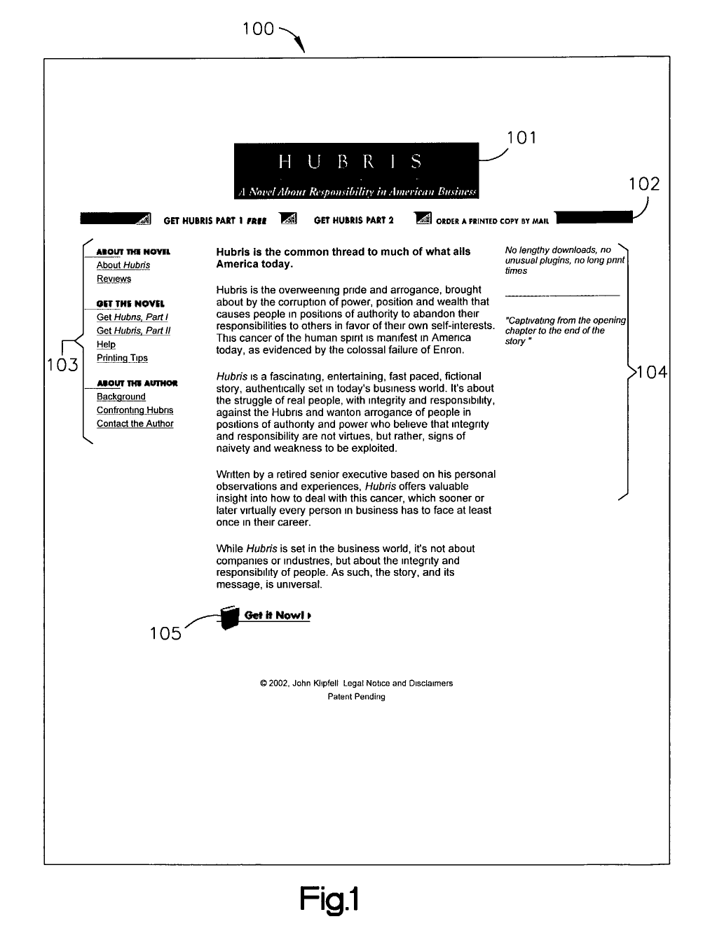

FIG. 1 is a representation of a website page 100, as one of a series of pages maintained on a website of the publisher or distributor of the work. Page 100 has a header 101 which may contain a title or heading of the work, and a navigation bar 102 with links to various methods of acquiring the work. The logical division of the work into parts may be represented by separate buttons on the navigation bar. Related links may be located in field 103, such as further information about the work, author or subject, and technical details on accomplishing transfer of the work data. Field 104 is the main content portion of the page 100, and may contain further description of the work, or a general introduction to the work. Hyperlink 105 may function simply as a browser Forward button, or a link to additional information on acquiring all or a portion of the work.

The work of literary composition titled Hubris is the equivalent of about a 225-page paperback novel, but intentionally formatted to print, in two parts, on a total of about fifty-five, standard, 8½″ by 11″ sheets of paper. Each 27 or 28 page part of Hubris can be printed in as little as five minutes on many common home printers. The formatting of Hubris to permit it to be displayed and printed on only about fifty-five pages was accomplished by: 1) reducing the text font size slightly from font sizes typically utilized in paperback novels, while still being easily readable; 2) eliminating the lengthy page breaks customary between chapters of a typical paperback novel; and, 3) putting the equivalent of 3.7 pages of customarily sized paperback novel text in an attractive, easy to read three column horizontal format on a standard sized, 8½″ by 11″ sheet of paper. The purpose of this formatting was to both to facilitate the marketing plan for Hubris, as well as the application of the invention described in this patent application. Other formats might well be devised for other types of literary composition or other forms of intellectual property, which might result in other preferred embodiments of the invention appropriate for those works and properties.

In this preferred embodiment, the work of literary composition titled Hubris is offered to the end-consumer public through a printable and/or viewable electronic file, accessible from the Internet at the publisher's website, HubrisBooks.com. This preferred embodiment permits the end-consumer to simply, easily, and quickly download and either print the electronic file on a home or other printer, and/or view the file on a standard computer monitor or on any other compatible electronic device, as represented by the selection options in fields 102 and 103, or via link 105. The downloadable electronic file is in the widely used, industry standard file format known as the Abode Acrobat PDF format. This file format is believed to be already available on more than 95% of all United States personal computers. Hence, in the usual case, no unusual software, or software plug-in, is necessary for the typical end-consumer.

In this preferred embodiment, the work of literary composition titled Hubris has been divided into two parts. Part I is available for free and is about 27 electronic pages in length. Part II is available for a fee and is about 28 electronic pages in length. Each of Parts I and II are in turn made available to the end-consumer in three different formats, which the end-consumer can interchangeably access and use. One format allows the end-consumer to download and print the entire Part I or Part II all at one time. Another format allows the end-consumer to download and print Part I or Part II in three different 9 or 10 page segments. Yet another format allows the end-consumer to download and view the entire Part I or part II on their personal computer and monitor, or other device.

In this preferred embodiment, the marketing and distribution process for the work of literary composition titled Hubris is as follows. The first step in the process is to conduct a typical on-line and off-line marketing campaign to attract an initial group of several hundred or more end-consumers to the HubrisBooks.com website for the purpose of getting them to download the electronic file and either print and/or view on their computer monitor or other device the free Part I of the work. That portion of this initial group of end-consumers that found Part I of the work to be appealing enough for them to decide that they wished to read Part II of the work are directed to return to the HubrisBooks.com website where they will be offered a choice. If they wish to download the electronic file for Part II and either print and/or view it on their computer monitor, they can either choose to outright pay $4.95 for access to Part II by offering their credit card in payment, or alternatively, receive full access to Part II by sending at least three, and as many as five, personal endorsement e-mails to friends and associates recommending that they go to the HubrisBooks.com website and obtain the free Part I of the work.

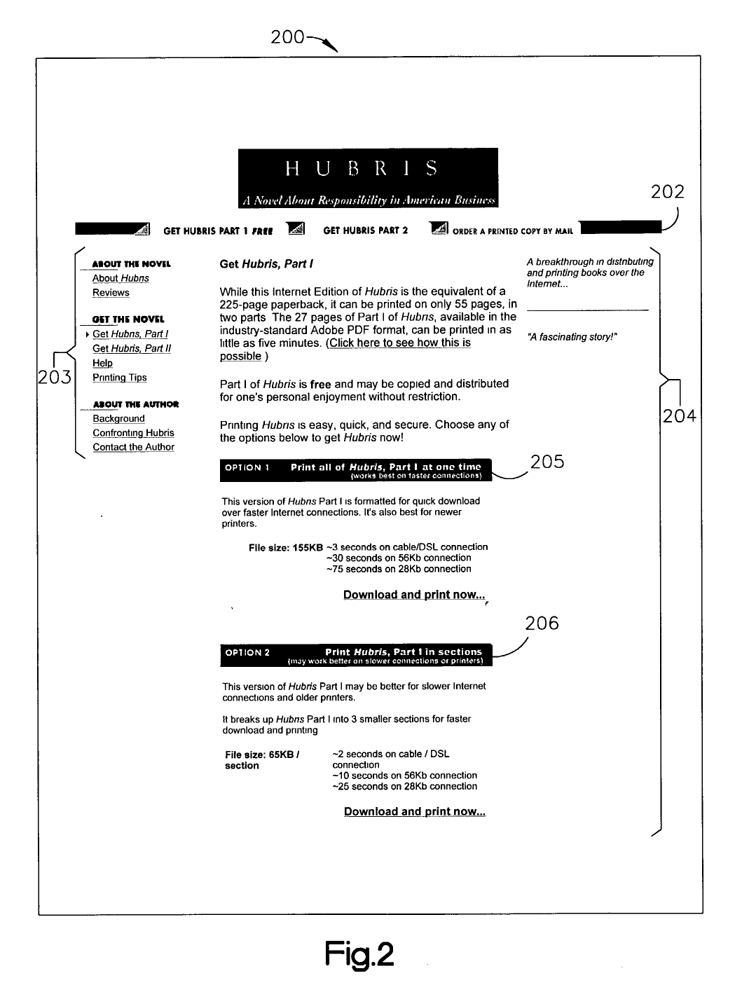

For example, FIG. 2 represents another web page 200 of the website linked to the “Get Hubris PART 1 FREE”. The text field 204 contains an explanation of options for acquiring PART I of the work, either by download, as further detailed and hyperlink activated under header 205, or by printing as further detailed and hyperlink activated under header 206.

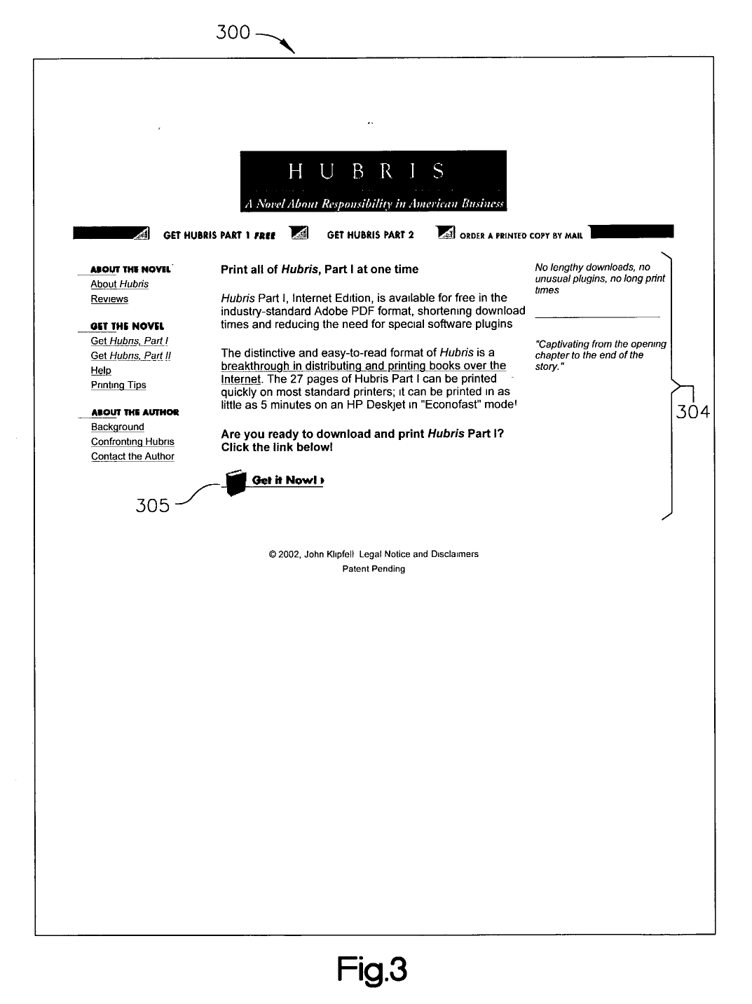

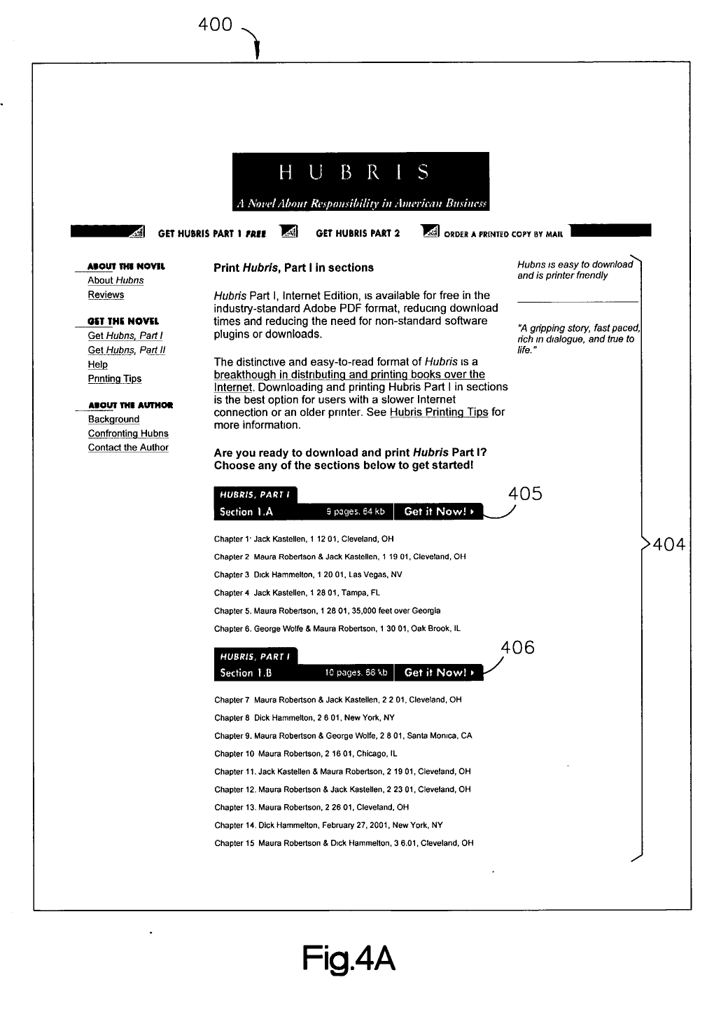

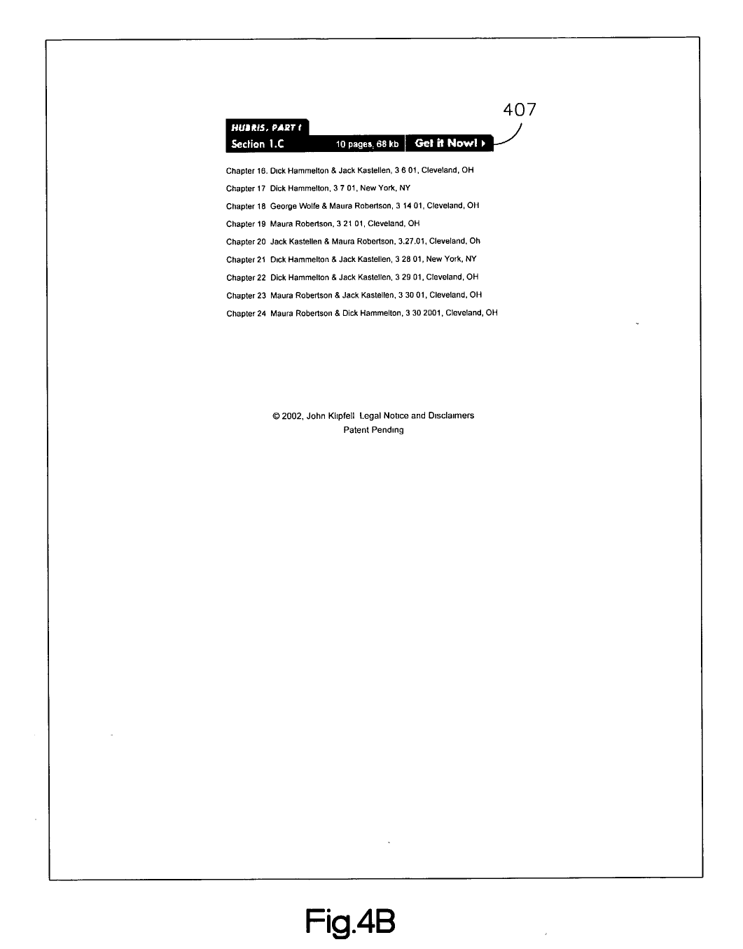

FIG. 3 represents a related web page 300 of the publisher/distributor website setting further description in the text field 304 on the expedited printing of a part of the work, and with a link 305 to detailed printing instructions and procedures, as set forth on page 400, FIGS. 4A and 4B. The text field 404 of page 400 sets forth printing options for PART 1 of the work, dividing into subparts or sections as listed under the headings 405, 406 and 407. Selection of any of these sections initiates the printing process for that section.

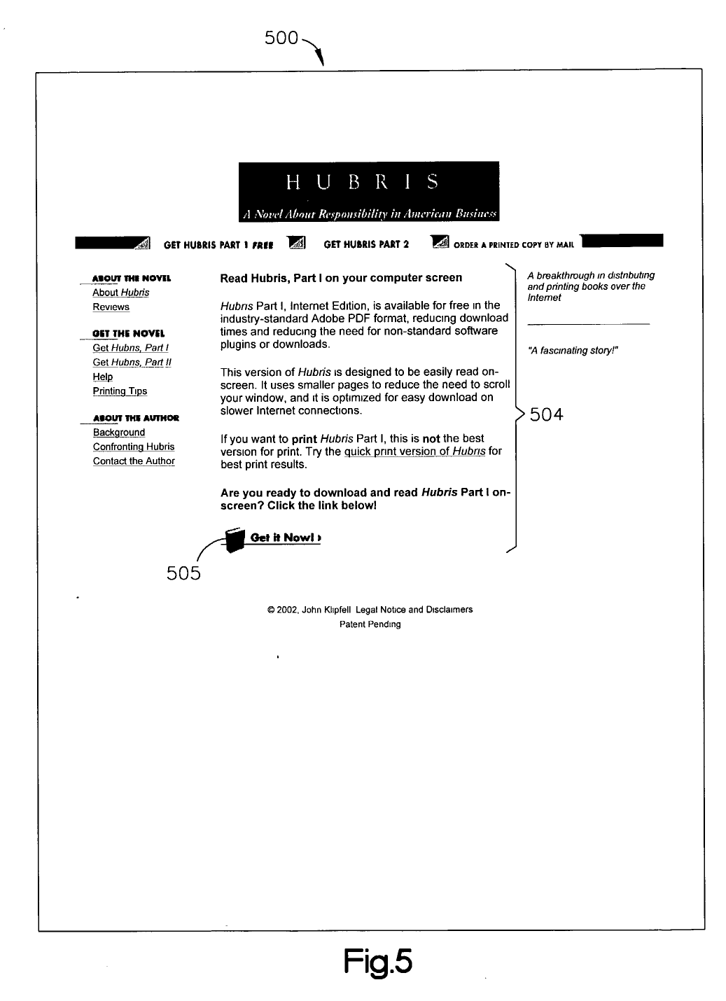

FIG. 5 represents a related web page 500 of the website which explains, in the text field 504, an alternate option for acquiring electronic access to PART I of the work by dynamic viewing on a display screen or monitor, with a link 505 which initiates the processing for accessing a computer-formatted version of the work for displayed viewing.

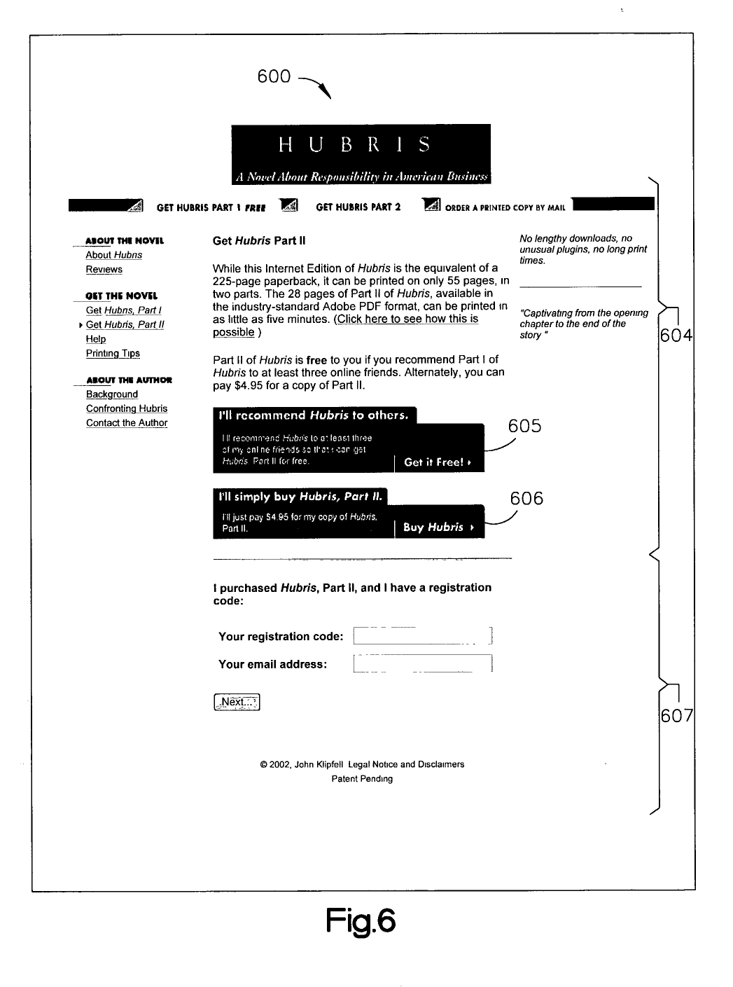

FIG. 6 represents a web page 600 which sets forth in the text field 604 various options for receiving PART II of the work. Header 605 provides a link to acquiring PART II through networked recommendation of the work to others. Header 606 provides a link to acquiring PART II by purchase. Field 607 provides an input for a registration code and e-mail address for purchasers of PART II in order to perform the electronic transfer of PART II to the purchaser.

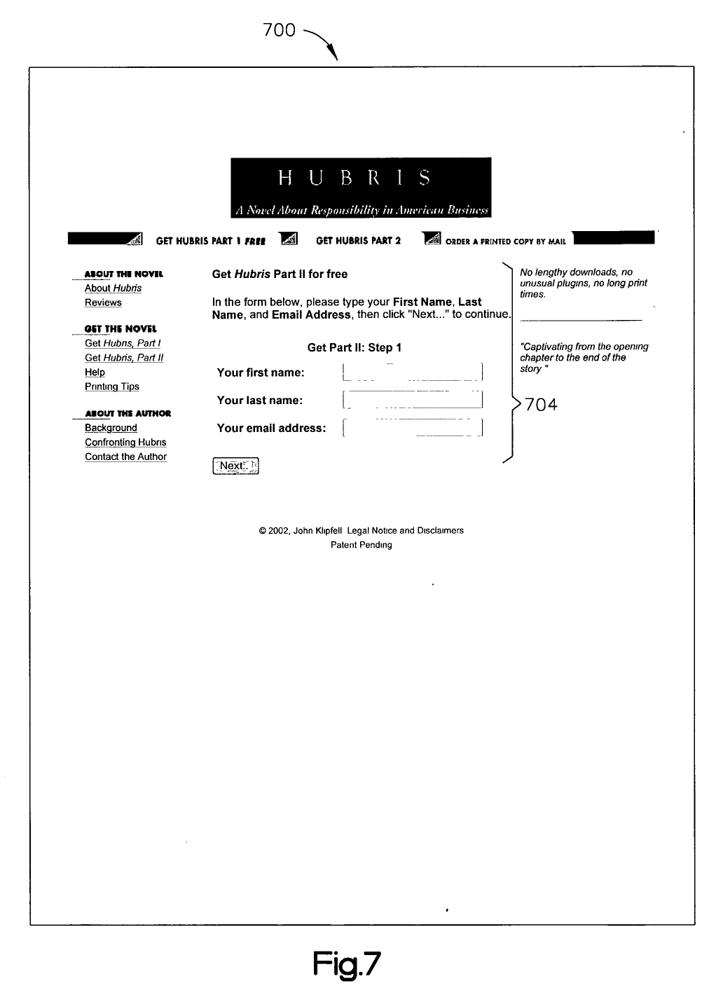

FIG. 7 represents a subsequent web page 700 of the website which gathers information, such as name, e-mail address, etc. on a recipient of PART II for free in exchange for networked recommendation of the work to others. The data entry field 704 may further include additional information about the recipient, or gather related information pertaining to the work and its distribution.

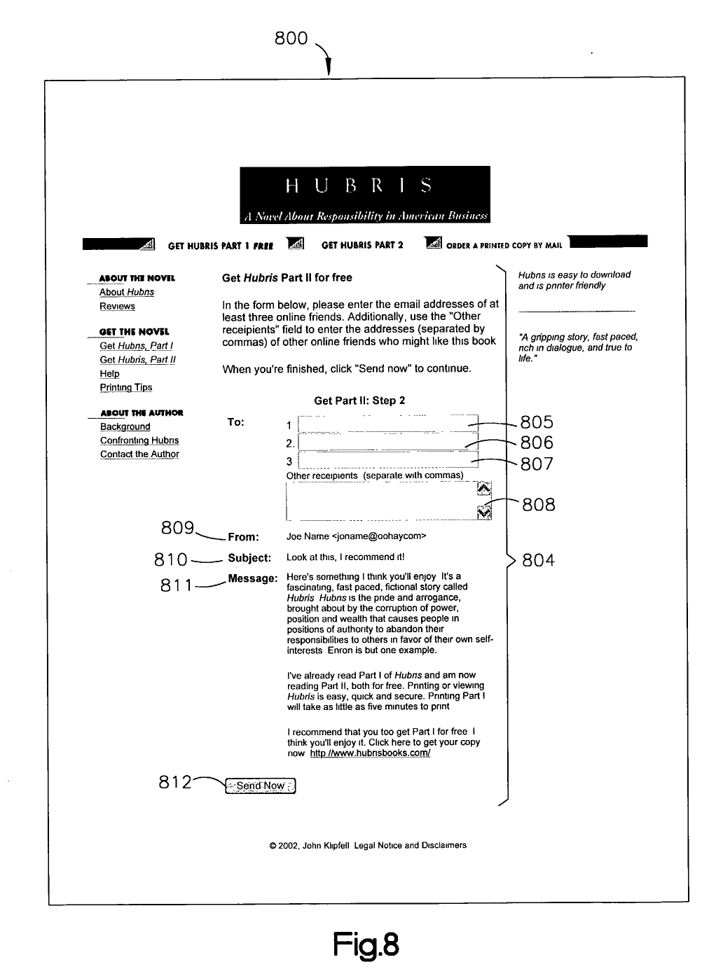

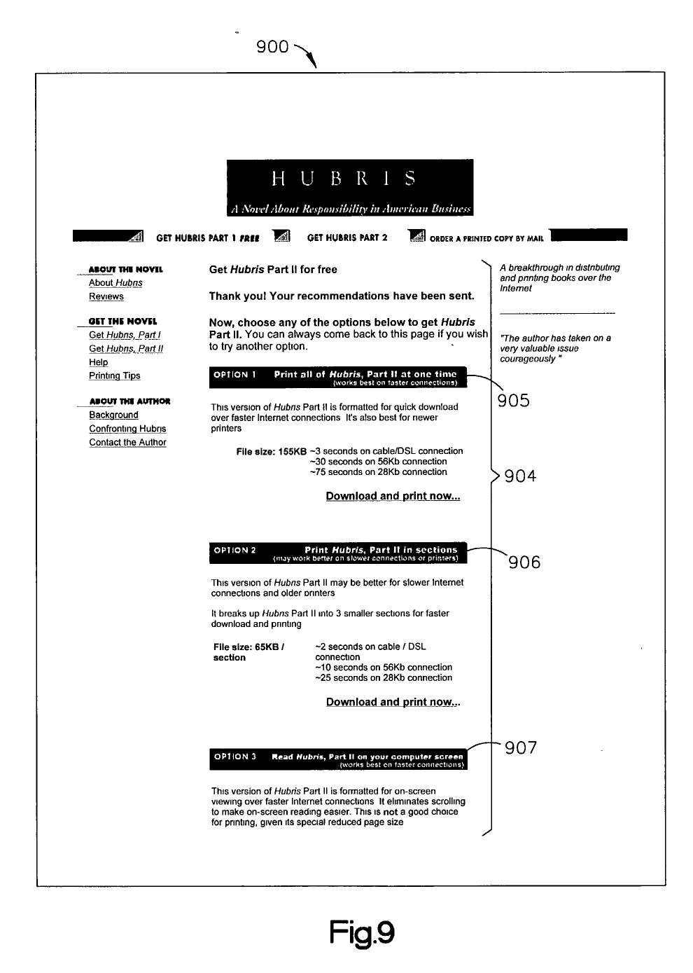

FIG. 8 represents a sequential web page 800 of the website on which e-mail addresses of referral recipients are input in the data entry boxes 805-808, within the text field 804. The text field 804 contains instructions on the form of input of e-mail addresses, located above boxes 805-808, and a broadcast e-mail message 811 below boxes 805-808. The message contains several key elements which contribute to the efficacy of the method of work distribution of the invention. The “From” line 809 immediately identifies the sender of the referral/message as a friend or acquaintance of the recipient, thus distinguishing the message from the class of unknown junk or “spam” e-mails commonly broadcast by commercial concerns offering products for sale and containing a link to a website. The “Subject” line 810 is preferably a personalized message which urges or entices the recipient to open the e-mail on the basis of a genuine referral from an acquaintance. This is very different from the more commercially crass approach of naming a product or announcing a sale in the subject line, which commonly prompts deletion of the e-mail without even opening the message. The “Message” 811 is similarly personalized, giving for example a brief but genuine assessment of the subject work, explanation of the methods by which it can be acquired, and a link to the hosting website. In this form, a personalized e-mail functions to network information about the work and the expeditious way in which it can be acquired or disseminated. Upon completion of the e-mail address data entry, the user clicks on the send button 812 to send the messages, and which directs the sender to the subsequent page 900 of the website, represented by FIG. 9.

The text field 904 of page 900 thanks the user for the e-mail referrals of the work, and immediately directs the user to the various options for acquiring PART II of the work. For example, header 905 and the information therebelow is a bulk print option whereby all of PART II is printed in one printing operation. Header 906 enables printing of PART II in sections. And header 907 enables on-line or displayed viewing of PART II.

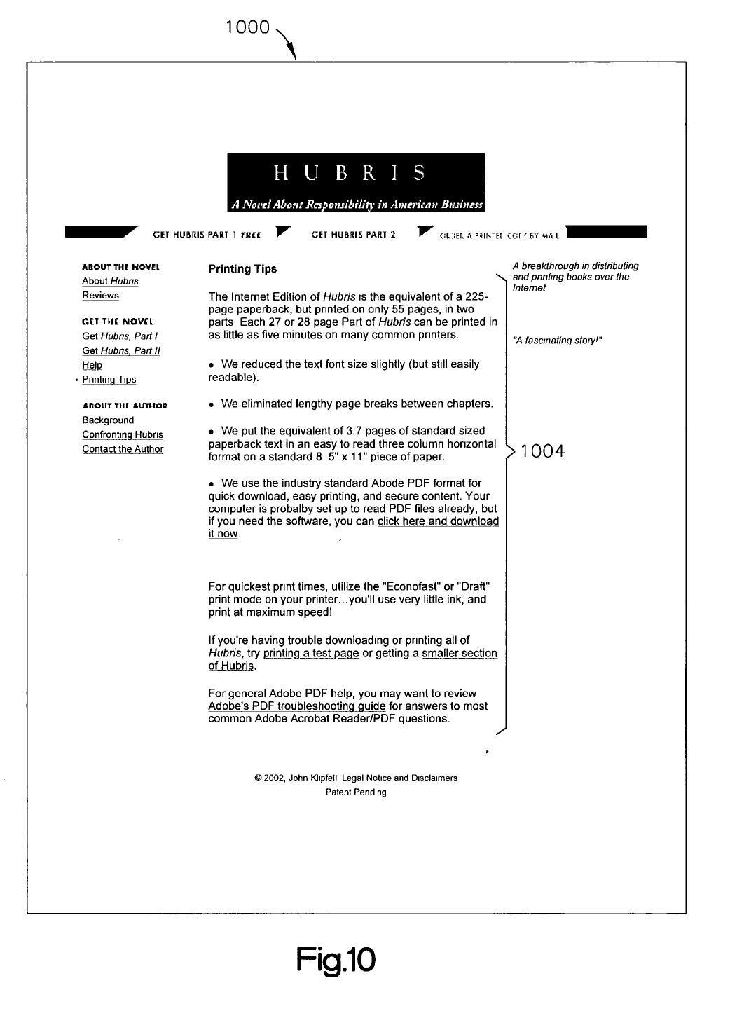

FIG. 10 represents a related web page 1000 of the website in which the text field 1004 contains helpful information on printing of the work. Such information may include, for example, total number of printed pages required, formatting, font size, and links to any software, such as Adobe Acrobat, required to print the work in the correct format.

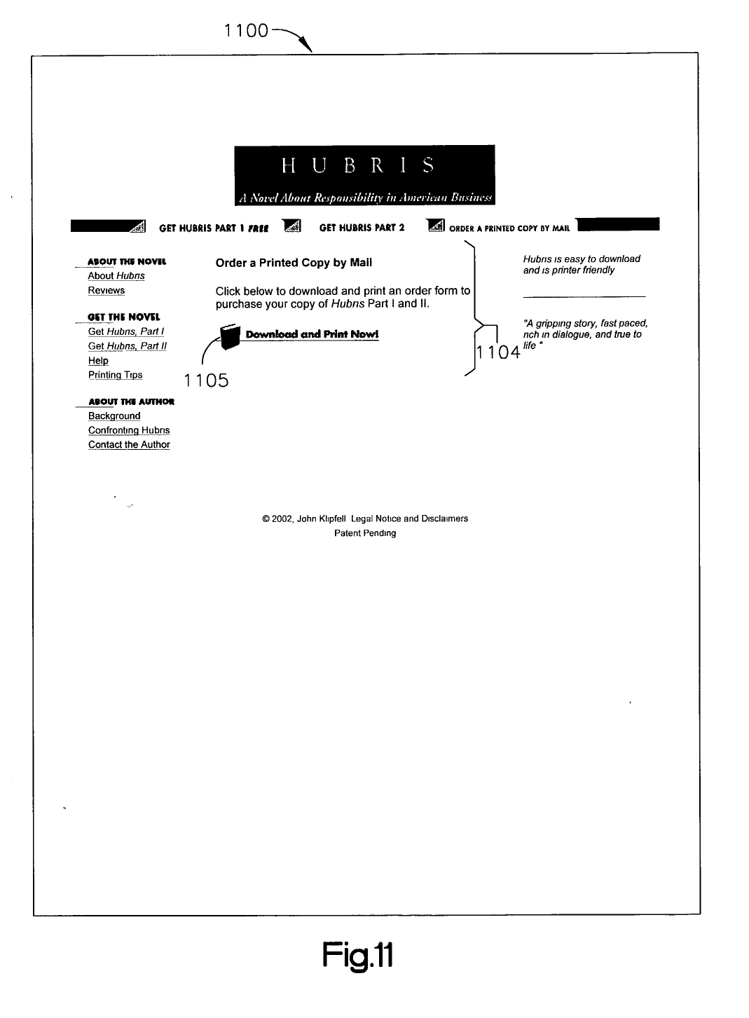

FIG. 11 represents a related web page 1100 of the website in which the text field 1104 contains a link 1105 to produce a conventional mail order form for purchase of the work, the order form being of the standard type for filling out purchaser name and address and manner of payment, and the mailing address of the order processor or distributor of the work.

It is anticipated that some portion of those friends and associates that receive the personal endorsement e-mails from earlier readers of Part I of the work will ignore the personal endorsement e-mail and some will act on it. Of those that act on it and access, download, and print and/or view the free Part I of the work, some portion will take no further action, some portion will choose to buy Part II outright for the stated fee, and some portion will choose to send personal endorsement e-mails to yet other friends and associates, which will in turn start this marketing and distribution cycle all over again. The expectation of this marketing and distribution plan for the work of literary composition titled Hubris, which is a preferred embodiment of this invention, is that an ever increasing number of end-consumers will become aware of the existence of the work, and will eventually read and enjoy it.

There are many potential variations about how the above process could work. For example, it might have been structured such that if one personal endorsement e-mail was sent, the sender would receive a $1.00 discount off the stated price of Part II, if two personal endorsement e-mails were sent, the sender would receive $2.00 off the stated price of Part II, if three personal endorsement e-mails were sent, the sender would receive $3.00 off the stated price of Part II, and so on. These type of marketing or compensation rules can be readily implemented and explained on the appropriate described web pages of the work distribution website.

In the preferred embodiment described above, the personal endorsement e-mails that will be sent will be pre-formatted and pre-worded, offering no latitude to the sender to modify the pre-worded message. All the personal endorsement e-mail sender has to do is provide his or her own e-mail address and name, and the e-mail addresses of three to five parties to whom he or she wishes to send the personal endorsement e-mail. When that is done, personal endorsement e-mails will be individually sent out in the senders name to the listed e-mail address, which will have been previously tested for syntax and validity.

The compensated, personal endorsement e-mail marketing process of this invention provides a needed means for getting the word out about the existence and consumer appeal of a work of literary composition or other form of intellectual property to the universe composed of the hundreds of millions of potential end-consumers who can electronically access and acquire it over the Internet. In doing so, the invention provides:

a means by which an author or publisher of a work of literary composition or other similar form of intellectual property, including relatively unknown or unpublished persons, can successfully publish, market, and distribute their work electronically, utilizing compensated e-mail marketing to reach a large number of end-consumers;

a means by which a personal e-mail from an end-consumer is utilized to endorse and promote a work of literary composition or other form of intellectual property that circumvents to some degree the software filters and other restrictions that other end-consumers might use to screen unsolicited incoming e-mails;

a means for encouraging trial or inspection by an end-consumer of a work of literary composition or other similar form of intellectual property through the use of a free portion and a for-fee portion of the work so that the end-consumer can determine if a work is sufficiently appealing for them to want to acquire the for-fee remainder of the work.

Although the descriptions above contain many specificities, these should not be construed as limiting the scope of the invention, but as merely providing illustrations of some of the presently preferred embodiments of this invention. Thus the scope of the invention should be determined by the appended claims and their legal equivalents, rather than by the examples given.

What is claimed is:

1. A method for informing end-consumers with Internet access of the existence of a work of intellectual property with potential end-consumer appeal, and encouraging said end-users to acquire said work of intellectual property for their use, comprising the steps of:
providing an initial end-consumer with a free sample portion of said work of intellectual property sufficient for said initial end-consumer to determine if said work of intellectual property has sufficient appeal to said initial end-consumer to convince said initial end-consumer to acquire the balance of said work of intellectual property for said initial end-consumer's use, and
providing said initial end-consumer, who has made a determination to acquire the balance of said work of intellectual property, with a choice of giving one of at least two different forms of compensation in exchange for acquiring said balance of said work of intellectual property for their use, and where one of the choices is to acquire said balance of said work of intellectual property for a stated price or amount of financial consideration, and another choice is to acquire said balance of said work of intellectual property either for free or for a reduced price or amount of financial consideration in consideration of the following step, and
providing that for said initial end-consumer to be eligible to acquire said balance of said work of intellectual property either for free or for a reduced price or amount of financial consideration, said initial end-consumer must agree to send one or more e-mails or electronic communications to one or more other end-consumers, recommending or endorsing said work of intellectual property to said other end-consumers for their trial
or use, and
providing that said other end-consumers are in turn informed of the existence of said work of intellectual property through their receipt of one of the recommending or endorsing e-mails or electronic communications from one of the initial end-consumers, and encouraged to acquire said work of intellectual property for their use through the same method and process and steps stated above for an initial end-consumer,
whereby said initial and other end-consumers are able to acquire and use said work of intellectual property.

2. The method of claim 1 wherein said work of intellectual property is a work of literary composition representable by transferable data and divisible into parts.

3. The method of claim 1 applied to networked notification and distribution in parts of a work of musical, audio, video or audio/visual composition.

4. The method of claim 1 further comprising a choice to acquire the work of intellectual property for free or for a reduced price or amount of financial consideration of claim 1 wherein the choice includes the offering of a percentage or fixed monetary discount if a certain number of recommending or endorsement e-mails or electronic communications are sent to one or more other end-consumers.

5. The method of claim 1 including e-mail or electronic communication by the initial end-consumer to one or more other end-consumers of claim 1 wherein the e-mail or electronic communication is predetermined in terms of wording or format and not subject to significant change by the initial end-consumer.

6. The method of claim 1 including e-mail or electronic communication by the initial end-consumer to one or more other end-consumers of claim 1 wherein the e-mail or electronic communication is not predetermined in terms of wording or format and is subject to change or modification by the initial end-consumer.

7. The method of claim 1 including e-mail or electronic communication by the initial end-consumer to one or more other end-consumers of claim 1 wherein the e-mail or electronic communication includes the e-mail address, name, or other personal descriptor of the initial end-consumer.

8. The method of claim 1 including e-mail or electronic communication by the initial end-consumer to one or more other end-consumers of claim 1 wherein the e-mail or electronic communication includes an electronic link to the Internet site where the free sample portion of the work of intellectual property is provided for end-consumers to determine if they wish to acquire the balance of said work of intellectual property.

9. A system for electronic distribution of a work via a network, the system comprising:
a host server on which data representing the work resides; the host server having a browser interface;
a first recipient electronically connected to the server and browser via a network, the server and browser being programmed to make available to the first recipient data representing a first part of the work, and alternate procedures for thereafter receiving data representing a second part of the work;
one of said alternate procedures being payment for receipt of data representing a second part of the work, and another of said alternate procedures requiring notification by the first recipient via an electronic network to a prospective second recipient of existence and availability of the work in electronic form from the server, said notification of the prospective second recipient by the first recipient being a pre-requisite to the first recipient receiving the second part of the work.

10. The system of claim 9 wherein the host server and browser are in the form of an Internet website having multiple related web pages with graphical and textual data pertaining to the work and procedures for acquiring access to the work.

11. The system of claim 9 programmed to make a first part of the work accessible to a first recipient by download transfer of data representing the first part of the work for printing or viewing on a display screen.

12. The system of claim 9 programmed to present information to a first recipient of a first part of the work on at least two alternate procedures for receiving data representing a second part of the work, wherein one procedure is payment for the second part of the work and providing for input of required data for electronically processing payment for the second part of the work, and another procedure is notification via a network to at least one prospective second recipient of the work and providing for input of data for sending an electronic message to the prospective second recipient.

13. The system of claim 9 programmed to require networked notification by the first recipient to two or more prospective other recipient as a condition precedent to the first recipient receiving data from the server representing a second part of the work.

14. The system of claim 9 programmed to record a number of networked referrals of the work sent by the first recipient.

15. The system of claim 9 programmed to record a number of networked referrals of the work sent by the first recipient and to determine a credit award to the first recipient in exchange for said referrals.
